(19) United States
(12) Patent Application Publication
(10) Pub. No.: US 2025/0378794 A1
(43) Pub. Date: Dec. 11, 2025

(54) DISPLAY DEVICE AND ELECTRONIC DEVICE INCLUDING THE SAME

(71) Applicant: Samsung Display Co., LTD., Yongin-si (KR)

(72) Inventors: You Ra KIM, Yongin-si (KR); Yong Jo KIM, Yongin-si (KR); Hyo Sun KIM, Yongin-si (KR); Hyung Suk HWANG, Yongin-si (KR)

(21) Appl. No.: 19/068,267

(22) Filed: Mar. 3, 2025

(30) Foreign Application Priority Data
Jun. 11, 2024 (KR) 10-2024-0075697

(51) Int. Cl. G09G 3/3275

(52) U.S. Cl. CPC G09G 3/3275; G09G 2310/08; G09G 2320/0247; G09G 2320/0257; G09G 2320/0271; G09G 2320/0626

(57) ABSTRACT

A display device includes a display panel, where the display panel includes a pixel and displays an image. The driver converts input image data into image data, generates a data signal based on the image data, and provides the data signal to the pixel according to a refresh rate. When changing the refresh rate from a first refresh rate to a second refresh rate to display an image with a first luminance, the driver adjusts a luminance of a first frame in which the image is displayed at the second refresh rate to a second luminance which is different from the first luminance.

The application claims priority to Korean Patent Application No. 10-2024-0075697, filed on Jun. 11, 2024, and all the benefits accruing therefrom under 35 U.S.C. § 119, the content of which in its entirety is herein incorporated by reference.

### BACKGROUND

### 1. Field

The present invention relates to a display device and, more particularly, a display device and an electronic device including the same.

### 2. Discussion of Related Art

A display device includes a plurality of pixels, where each of the pixels includes a plurality of transistors, a light emitting element electrically connected to the plurality of transistors, and a capacitor. The plurality of transistors are turned on in response to signals provided through wirings, thereby generating a predetermined driving current, where the light emitting element emits light in response to this driving current.

### SUMMARY

An embodiment provides a display device capable of improving visibility and an electronic device including the same.

In an embodiment, a display device may include a display panel including a pixel and displaying an image and a driver converting input image data into image data, generating a data signal based on the image data, and providing the data signal to the pixel according to a refresh rate. When changing the refresh rate from a first refresh rate to a second refresh rate to display an image with a first luminance, the driver may adjust a luminance of a first frame in which the image is displayed at the second refresh rate to a second luminance which is different from the first luminance.

In an embodiment, when the second refresh rate is smaller than the first refresh rate, the driver may reduce the second luminance to be lower than the first luminance.

In an embodiment, in response to a change in the refresh rate, the driver may change an on-duty, which represents a ratio of time in which the pixel emits light during one frame, and a peak luminance according to the time of the image.

In an embodiment, the driver may adjust the peak luminance according to the time of the image in the first frame to be between a first peak luminance according to the first refresh rate and a second peak luminance according to the second refresh rate.

In an embodiment, the peak luminance of the first frame may be within a range of about 85% to about 97% of the second peak luminance.

In an embodiment, the peak luminance of the first frame may be within a range of about ±10% of an average of the first peak luminance and the second peak luminance.

In an embodiment, the driver may select one of the gamma voltages based on a grayscale value of the image data for the pixel and output the selected gamma voltage as the data signal, and set the gamma voltages in the first frame to be different than the gamma voltages for the second peak luminance.

In an embodiment, the driver may convert the input image data into the image data based on the refresh rate and apply a weight to generate the image data of the first frame.

In an embodiment, the driver may drive the display panel to display the image having the first luminance in a second frame after the first frame.

In an embodiment, when a difference between the first refresh rate and the second refresh rate is greater than a reference value, the driver may adjust the luminance of a second frame after the first frame to be between the first luminance and the second luminance.

In an embodiment, when the second refresh rate is smaller than the first refresh rate, the driver may increase the second luminance to be higher than the first luminance.

In an embodiment, then a difference or ratio between the first refresh rate and the second refresh rate is outside of a reference range, the driver may adjust the luminance of the first frame to be equal to the second luminance, and when the difference or ratio is within the reference range, the driver may maintain the luminance of the first frame at the first luminance.

In an embodiment, an electronic device may include a processor providing input image data and a display device displaying an image having a first luminance that corresponds to the input image data. When the processor changes a refresh rate of the image from a first refresh rate to a second refresh rate, the display device may display the image at a second luminance which is different from the first luminance for at least one frame, and display the image at the first luminance after the at least one frame.

In an embodiment, then the second refresh rate is smaller than the first refresh rate, the display device may reduce the second luminance to be lower than the first luminance.

In an embodiment, the display device may change a peak luminance according to the time of the image according to the refresh rate, and adjust the peak luminance in the at least one frame to be between a first peak luminance according to the first refresh rate and a second peak luminance according to the second refresh rate.

In an embodiment, a display device may include a display panel including a pixel and displaying an image and a driver converting the input image data into image data, generating a data signal based on the image data, and providing the data signal to the pixel according to a refresh rate. When changing the refresh rate from a first refresh rate to a second refresh rate to display an image with a first luminance, in a third section between a first section displaying the image at the first refresh rate and a second section displaying the image at the second refresh rate, the driver may adjust a luminance of the image to a second luminance which is different from the first luminance.

In an embodiment, the driver may adjust the refresh rate of the image to a third refresh rate which is different from the first refresh rate and the second refresh rate in the third section.

In an embodiment, the third refresh rate may be a value between the first refresh rate and the second refresh rate.

In an embodiment, the driver may change a peak luminance according to the time of the image according to the refresh rate, and adjust the peak luminance in the third section to be between a first peak luminance according to the first refresh rate and a second peak luminance according to the second refresh rate.

In an embodiment, the third section may include two or less frames.

Other specific details of embodiments are included in the detailed description and accompanying drawings.

### BRIEF DESCRIPTION OF THE DRAWINGS

The accompanying drawings, which are included to provide a further understanding of the invention, and are incorporated in and constitute a part of this specification, illustrate exemplary embodiments of the invention, and, together with the description, serve to explain principles of the invention.

FIG. 1 is a schematic block diagram illustrating a display device, according to an embodiment.

FIG. 2A is a conceptual diagram for explaining an example of a method of driving the display device according to an image refresh rate, according to an embodiment.

FIG. 2B is a conceptual diagram for explaining an example of a method of driving the display device according to an image refresh rate, according to an embodiment.

FIG. 2C is a conceptual diagram for explaining an example of a method of driving the display device according to an image refresh rate, according to an embodiment.

FIG. 3A is a graph for explaining a comparative example of actual luminance according to a change in image refresh rate, according to an embodiment.

FIG. 3B is a graph for explaining a comparative example of perceived luminance according to a change in image refresh rate, according to an embodiment.

FIG. 4 is a operational block diagram illustrating an image controller included in the display device of FIG. 1, according to an embodiment.

FIG. 5 is a timing diagram illustrating changes in luminance according to changes in image refresh rate, according to an embodiment.

FIG. 6 is a timing diagram illustrating changes in luminance according to changes in image refresh rate, according to an embodiment.

FIG. 7 is a timing diagram illustrating changes in luminance according to changes in image refresh rate, according to an embodiment.

FIG. 8 is a timing diagram illustrating changes in luminance according to changes in image refresh rate, according to an embodiment.

FIG. 9 is a timing diagram illustrating changes in luminance according to changes in image refresh rate, according to an embodiment.

FIG. 10 is a timing diagram illustrating changes in luminance according to changes in image refresh rate, according to an embodiment.

FIG. 11 is a timing diagram illustrating changes in luminance according to changes in image refresh rate, according to an embodiment.

FIG. 12 is a block diagram illustrating an electronic device, according to an embodiment.

### DETAILED DESCRIPTION

As the invention allows for various changes and numerous embodiments, particular embodiments will be illustrated in the drawings and described in detail in the written description. However, this is not intended to limit the invention to particular modes of practice.

It will be understood that, although the terms “first”, “second”, etc. may be used herein to describe various elements, these elements should not be limited by these terms. These terms are only used to distinguish one element from another element. For instance, a first element discussed below could be termed a second element without departing from the scope of the present disclosure. Similarly, the second element could also be termed the first element. In the disclosure, the singular expressions are intended to include the plural expressions as well, unless the context clearly indicates otherwise. Some embodiments are described in the accompanying drawings in relation to functional block, unit, and/or module. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, and may optionally be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the invention. In addition, in some embodiments, the block, unit and/or module may be physically combined into more complex blocks, units, and/or modules without departing from the scope of the invention.

Hereinafter, a display device, according to an embodiment, will be described with reference to drawings related to the embodiments of the invention.

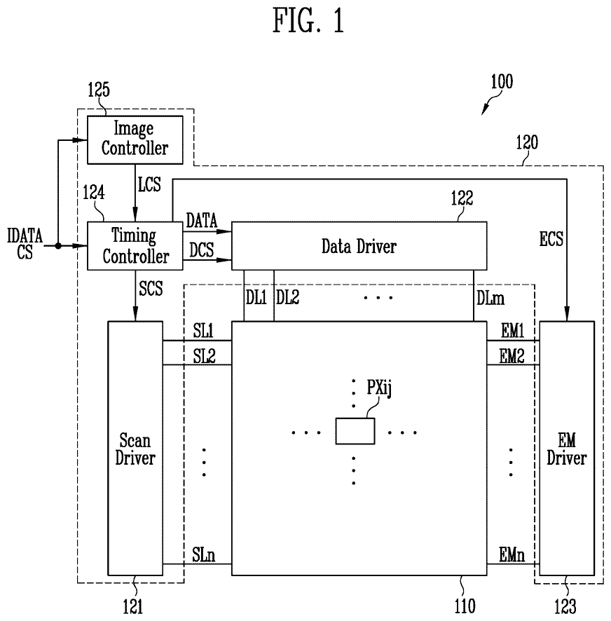

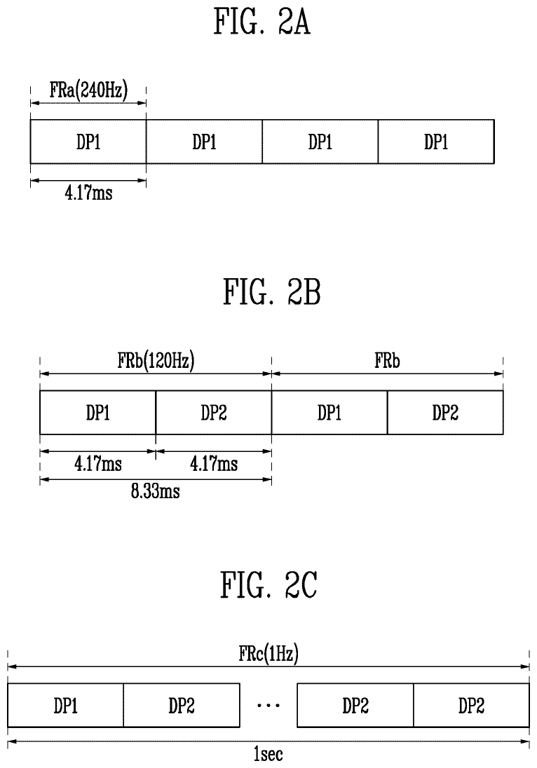

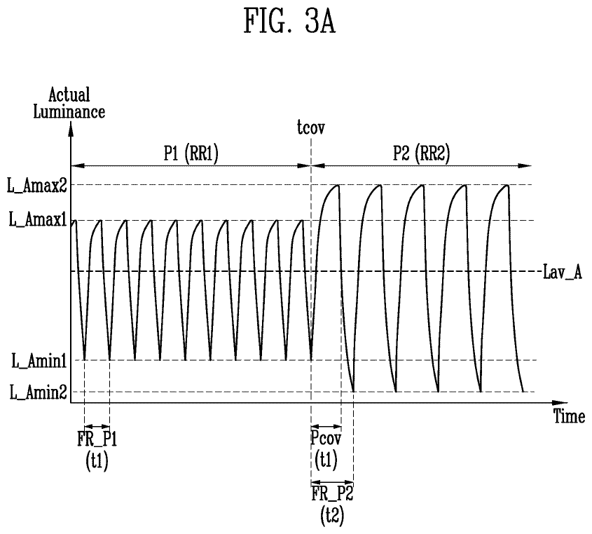

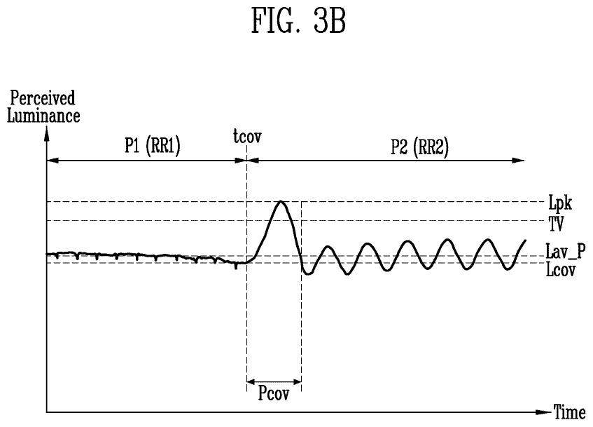

FIG. 1 is a block diagram illustrating a display device, according to an embodiment. FIGS. 2A, 2B, and 2C are conceptual diagrams for explaining an example of a method of driving the display device according to an image refresh rate, according to an embodiment. FIG. 3A is a graph for explaining a comparative example of actual luminance according to a change in image refresh rate, according to an embodiment. FIG. 3B is a graph for explaining a comparative example of perceived luminance according to a change in image refresh rate, according to an embodiment.

Referring to FIG. 1, a display device 100 may include a display panel 110 and a driver 120, according to an embodiment.

The display panel 110 (or display unit) may include a pixel PXij, where i and j may be integers greater than 0. Each pixel PXij may be connected to a corresponding data line and a corresponding scan line. Here, the pixel PXij may refer to a pixel in which a scan transistor is connected to an i-th scan line and a j-th data line. The pixel PXij may store or write a data signal provided through the j-th data line in response to a scan signal provided through the i-th scan line and emit light with a luminance corresponding to the stored data signal in response to an emission control signal provided through a j-th emission control line. The pixel PXij may include a light emitting element composed of an organic material and/or an inorganic material.

In an embodiment, the driver 120 may convert input image data IDATA into image data DATA, generate the data signal based on the image data DATA, and provide the data signal to the display panel 110 or the pixel PXij according to an image refresh rate (or refresh rate, hereinafter referred to as ‘refresh rate’).

The driver 120 may include a scan driver 121, a data driver 122, an emission driver (or EM driver) 123, a timing controller 124, and an image controller 125.

In an embodiment, the timing controller 124 may receive the input image data IDATA and a control signal CS from an external device (for example, a processor). Here, the control signal CS may include a synchronization signal, a clock signal, and the like.

In an embodiment, the timing controller 124 may generate a first control signal SCS (or scan drive control signal), a second control signal DCS (or data drive control signal), and a third control signal ECS (or emission drive control signal) based on the control signal CS. The timing controller 124 may provide the first control signal SCS to the scan driver 121, the second control signal DCS to the data driver 122, and the third control signal ECS to the emission driver 123.

The first control signal SCS may include a scan start signal, a scan clock signal, and the like. The scan start signal may be a signal for controlling the timing of the scan signal and the scan clock signal may be used to shift the scan start signal.

The second control signal DCS may include a source start signal, a data clock signal, and the like. The source start signal may control the start point of data sampling and the data clock signal may be used to control the sampling operation.

The third control signal ECS may include an emission start signal, an emission clock signal, and the like. The emission start signal may be a signal for controlling the timing of the emission control signal and the emission clock signal may be used to shift the emission start signal.

In an embodiment, the input image data IDATA may include grayscale values of an input image corresponding to at least one frame. For example, the input image data IDATA may include grayscale values of each of input images consecutive in units of frames.

In an embodiment, the timing controller 124 may generate the image data DATA based on the input image data IDATA and provide the image data DATA to the data driver 122.

In an embodiment, the scan driver 121 may supply the scan signal to scan lines SL1 to SLn based on the first control signal SCS, where n may be an integer greater than 0. For example, the scan driver 121 may sequentially supply the scan signal having a turn-on level pulse to the scan lines SL1 to SLn.

When the scan signal of a turn-on level is sequentially supplied, the pixel PXij may be selected in units of horizontal lines (or units of pixel rows), and the data signal may be supplied to the selected pixel PXij. To this end, the scan signal of the turn-on level may be set to a gate-on voltage (low voltage or high voltage) so that a transistor included in each pixel PXij and receiving the scan signal can be turned on.

In an embodiment, the data driver 122 may supply the data signal (or data voltage) corresponding to the image data DATA to data lines DL1 to DLm in response to the second control signal DCS, where m may be an integer greater than 0. The data signal supplied to the data lines DL1 to DLm may be supplied to the pixel PXij selected by the scan signal. To this end, the data driver 122 may supply the data signal to the data lines DLI to DLm in synchronization with the scan signal of the turn-on level.

In an embodiment, the emission driver 123 may supply the emission control signal to emission control lines EM1 to EMn based on the third control signal ECS. For example, the emission driver 123 may sequentially supply the emission control signal having a turn-on level pulse to the emission control lines EM1 to EMn. When the emission control signal of a turn-on level is supplied, the pixel PXij may emit light with a luminance corresponding to the data signal. The emission time of the pixel PXij may be determined by a width (that is, pulse width) of the emission control signal of the turn-on level.

In an embodiment, the display device 100 may display an image at various refresh rates (driving frequencies or screen refresh rates) depending on driving conditions. A refresh rate may refer to the frequency at which a valid data signal is written to the pixel PXij (for example, a driving transistor included in the pixel PXij). For example, the refresh rate may also be referred to as a screen refresh rate or a screen refresh frequency, and may indicate the frequency at which a display screen is refreshed per second.

In an embodiment, in response to the refresh rate, an output frequency of the data driver 122, an output frequency of the scan driver 121, and/or an output frequency of the emission driver 123 for one horizontal line (or pixel row) may be determined. For example, the refresh rate for driving a moving image may be a frequency of about 120 Hz or higher (for example, 120 Hz, 240 Hz, 360 Hz, 480 Hz, or the like), and the refresh rate for driving a still image may be a frequency of about 60Hz or less (for example, 30 Hz, 60 Hz, or the like). However, this is merely an example, and the invention is not limited thereto.

In an embodiment, to improve image quality, one frame period may include a plurality of non-emission periods and a plurality of emission periods depending on the refresh rate. For example, a first non-emission period and emission period of one frame may be defined as a first driving period, and subsequent non-emission period and emission period may be defined as a second driving period. During the first driving period, a valid image corresponding to the image data DATA may be displayed on the display panel 110. During the second driving period, a black image (for example, an image to prevent afterimages) may be displayed on the display panel 110, or a valid image may not be displayed on the display panel 110, but the invention is not limited thereto.

To describe the refresh rate in more detail, referring further to FIGS. 2A to 2C, the display device 100 may be driven at various refresh rates.

In an embodiment, the frequency of a first driving period DP1 may correspond to the refresh rate.

In an embodiment, as shown in FIG. 2A, one frame FRa may include the first driving period DP1. For example, when the frequency of the first driving period DP1 is about 240 Hz, a corresponding frame FRa may be driven at about 240 Hz. That is, the corresponding frame FRa may be driven at a refresh rate of about 240 Hz. For example, the length of the first driving period DP1 and the corresponding frame FRa may be about 4.17 ms.

In an embodiment, as shown in FIG. 2B, one frame FRb may include the first driving period DP1 and one second driving period DP2. For example, the first driving period DP1 and the second driving period DP2 may be repeated. For example, the first driving period DP1 and the second driving period DP2 may have the same length. In this case, a corresponding frame FRb may be driven at about 120 Hz. That is, the corresponding frame FRb may be driven at an image refresh rate of about 120 Hz. For example, the length of the first driving period DP1 and one second driving period DP2 may be about 4.17 ms, and the length of the corresponding frame FRb may be about 8.33 ms.

In an embodiment, as shown in FIG. 2C, one frame FRc may include one first driving period DP1 and a plurality of repeated second driving periods DP2. For example, when a corresponding frame FRc is driven at about 1 Hz, the length of the corresponding frame FRc may be about 1 second, and the second driving period DP2 may be repeated about 239 times within the corresponding frame FRc. That is, the corresponding frame FRc may be driven at an image refresh rate of about 1 Hz.

In this way, by controlling the number of repetitions of the second driving period DP2 within one frame, the display device 100 may be freely driven at various refresh rates (for example, 1 Hz to 480 Hz).

More specifically, at various refresh rates, the length of the first driving period DP1 and one second driving period DP2 may be fixed (for example, the length of the first driving period DP1 and the length of one second driving period DP2 may be fixed to about 4.17 ms corresponding to about 240 Hz), and the display device 100 may be driven at various refresh rates by controlling the number of repetitions of the second driving period DP2 within one frame. For example, as the number of second driving periods DP2 within one frame increases, the refresh rate of the display device 100 may decrease. As an example, when the number of second driving periods DP2 included in one frame is p, the display device 100 may be driven at a refresh rate of 240/(p+1) Hz, where p may be an integer that is greater than or equal to 0. That is, the refresh rate of the display device 100 may be set to a divisor of the frequency (for example, 240 Hz) corresponding to the length of the first driving period DP1 depending on the number of second driving periods DP2 included in one frame.

However, this is merely an example, and the length of the first driving period DP1 and the length of one second driving period DP2 may be fixed to about 2.08 ms corresponding to about 480 Hz, and the refresh rate of the display device 100 may be set to a divisor of about 480 Hz depending on the number of second driving periods DP2 included in one frame.

Additionally, when the refresh rate of the display device 100 changes (or switches) (for example, when the refresh rate switches from 120 Hz to 60 Hz, or from 240 Hz to 60 Hz), a transient flashing phenomenon may occur. For example, when the refresh rate of the display device 100 is switched, a user may perceive the luminance of the displayed image as temporarily increasing, and the user may perceive the displayed image as flashing (for example, a flicker phenomenon may be perceived by the user).

For example, referring further to FIGS. 3A and 3B, FIG. 3A shows a graph showing a comparative example of actual luminance when the display device is driven from a first refresh rate RR1 to a second refresh rate RR2. FIG. 3B shows a graph showing a comparative example of perceived luminance perceived by a user when the display device is driven from the first refresh rate RR1 to the second refresh rate RR2.

In an embodiment and referring to FIG. 3A, the display device, according to the comparative example, may be driven at the first refresh rate RR1 in a first period P1 (or first section) and may be driven at the second refresh rate RR2 in a second period P2 (or second section) after the first period P1. Here, the first refresh rate RR1 and the second refresh rate RR2 may be different from each other. For example, the first refresh rate RR1 may be greater than the second refresh rate RR2. As an example, the first refresh rate RR1 may be about 120 Hz, and the second refresh rate RR2 may be about 60 Hz. However, the invention is not limited thereto, and the second refresh rate RR2 may be greater than the first refresh rate RR1. Hereinafter, for convenience of description, the description will be based on a case where the first refresh rate RR1 is greater than the second refresh rate RR2.

In an embodiment, since the first refresh rate RR1 is greater than the second refresh rate RR2, the length (shown as ‘t1’) of each frame FR P1 in the first period P1 in which the display device is driven at the first refresh rate RR1 may be shorter than the length (shown as ‘t2’) of each frame FR_P2 in the second period P2 in which the display device is driven at the second refresh rate RR2 (for example, a cycle in which the data signal is written to the display device may be short). For example, when the display device is driven at the first refresh rate RR1 (for example, about 120 Hz), the data signal may be written with a cycle of about 8.33 ms, and when the display device is driven at the second refresh rate RR2 (for example, 60 Hz), the data signal may be written with a cycle of about 16.67 ms.

As shown in FIG. 3A, the display device, according to the comparative example, may be driven with the refresh rate switched from the first refresh rate RR1 to the second refresh rate RR2.

For convenience of description, the description will be based on an embodiment where the luminance of the image displayed by the display device according to the comparative example in the first period P1 is the same as the luminance of the image displayed by the display device according to the comparative example in the second period P2. For example, the image displayed by the display device, according to the comparative example, may have the same first average luminance Lav_A in the first period P1 and the second period P2.

In an embodiment and referring further to FIG. 3B, when the display device, according to the comparative example, is driven at the first refresh rate RR1 in the first period P1 and then the refresh rate is switched and driven at the second refresh rate RR2 in the second period P2, an average value of perceived luminance perceived by the user may have the same value in the first period P1 and the second period P2. For example, as described with reference to FIG. 3A, since the actual luminance of the image displayed by the display device has the same average value (for example, the first average luminance Lav_A) in the first period P1 and the second period P2, the perceived luminance perceived by the user may also have the same average value (for example, a second average luminance Lav_P) in the first period P1 and the second period P2.

However, when the refresh rate of the display device is switched, the transient flashing phenomenon, in which the user may perceive a temporary increase in the luminance of the displayed image, may occur.

In an embodiment and as shown in FIG. 3B, even if the average value of perceived luminance perceived by the user in the first period P1 and the second period P2 is the same as the second average luminance Lav_P, in response to the time point at which the refresh rate is switched from the first period P1 to the second period P2 (for example, immediately after the first period P1), the perceived luminance may temporarily increase due to the transient flashing phenomenon described above. For example, in response to the time point at which the refresh rate is switched from the first period P1 to the second period P2 (for example, in a transition period Pcov immediately after the first period P1), the perceived luminance may temporarily increase to a peak luminance Lpk (or flashing luminance). If the peak luminance Lpk is greater than or equal to a threshold value TV, even if the average luminance of a corresponding displayed image is the same when the refresh rate is switched, transient flashing (or flicker) may be perceived by the user the moment the refresh rate is switched. Here, the threshold value TV may refer to a reference value of flashing luminance at which the transient flashing phenomenon is perceived by the user (for example, a flicker is perceived by the user) when the refresh rate is switched.

In an embodiment, the larger the difference between a value of peak luminance Lpk (or flashing luminance) and a value of perceived luminance (shown as ‘Lcov’ in FIG. 3B) at the time point of transition from the first period P1 to the second period P2 (for example, a transition time point tcov), the more strongly the transient flashing phenomenon described above may occur. For example, the larger the difference between the value of peak luminance Lpk (or flashing luminance) and the value of perceived luminance Lcov at the time point of transition from the first period P1 to the second period P2, the more severe a flashing (or flicker) phenomenon in the displayed image perceived by the user may appear.

In an embodiment and as shown in FIG. 3A, during each frame FR P1 in the first period P1, the actual luminance may decrease from a first maximum luminance L_Amax1 to a first minimum luminance L_Amin1. For example, as a valid image is displayed in the first driving period DP1 of FIG. 2B, the actual luminance may increase to the first maximum luminance L_Amax1, and as a black image is displayed or a valid image is not displayed in the second driving period DP2, the actual luminance may decrease to the first minimum luminance L_Amin1. That is, in response to the refresh rate at which the display device is driven in the first period P1, the value of actual luminance may periodically change between a maximum luminance L_AMax and a minimum luminance L_AMin. Here, since the display device is generally driven at a refresh rate higher than a user's critical fusion frequency (CFF), the user does not perceive the luminance as changing periodically like the actual luminance shown in FIG. 3A, but rather, as shown in FIG. 3B, the user may perceive the luminance of the displayed image as constant in the first period P1. For example, the user may perceive that the luminance of the displayed image in the first period P1 has a constant value as the second average luminance Lav_P, which is an intermediate value between the maximum luminance L_AMax and the minimum luminance L_AMin.

Similarly, as shown in FIG. 3A, during each frame FR_P2 in the second period P2, the actual luminance may decrease from a second maximum luminance L_Amax2 to a second minimum luminance L_Amin2. For example, as the refresh rate decreases, the number or width of the second driving period DP2 of FIG. 2B may increase, and the maximum luminance (that is, the second maximum luminance L_Amax2) in the second period P2 may be greater than the maximum luminance (that is, the first maximum luminance L_Amax1) in the first period P1 so that each frame FR_P1 in the second period P2 has the same luminance (for example, the first average luminance Lav_A) as each frame FR_P1 in the first period P1. The minimum luminance (that is, the second minimum luminance L_Amin2) in the second period P2 may be lower than the minimum luminance (that is, the first minimum luminance L_Amin1) in the first period P1, but the present invention is not limited thereto. For example, the second minimum luminance L_Amin2 may be equal to the first minimum luminance L_Amin1. That is, in response to the refresh rate at which the display device is driven in the second period P2, the value of actual luminance may periodically change between the second maximum luminance L_Amax2 and the second minimum luminance L_Amin2. The user does not perceive the luminance as changing periodically like the actual luminance shown in FIG. 3A, but rather, as shown in FIG. 3B, the user may perceive the luminance of the displayed image as constant in the second period P2. For example, as described above, since the second refresh rate RR2 has a smaller value than the first refresh rate RR1, the second refresh rate RR2 may have a value closer to the user's critical fusion frequency. Accordingly, the perceived luminance perceived by the user in the second period P2 may slightly increase or slightly decrease based on the second average luminance Lav_P, but the actual user may perceive the luminance of the displayed image in the second period P2 as having an overall constant value as the second average luminance Lav_P, which is an intermediate value between the second maximum luminance L_Amax2 and the second minimum luminance L_Amin2.

Additionally, according to the Talbot-Plateau law, the perceived luminance of the displayed image perceived by the user may be determined according to the refresh rate of the corresponding image.

In an embodiment, when the refresh rate of the display device is switched from the first refresh rate RR1 to the second refresh rate RR2, due to a temporary change in the refresh rate, according to the Talbot-Plateau law described above, at the time point of transition from the first period P1 to the second period P2, an average value of the actual luminance during a period corresponding to the first refresh rate RR1 of the first period PI may be perceived by the user as the luminance of the displayed image.

For example, as shown in FIG. 3A, the user may perceive that the displayed image is displayed with the average value of the actual luminance during the transition period Pcov, which has the same length t1 as the first frame FR1 immediately after the first period P1. Accordingly, as shown in FIG. 3B, the perceived luminance perceived by the user in the transition period Pcov may temporarily increase to the peak luminance Lpk. Accordingly, the transient flashing phenomenon (or a flashing phenomenon in the displayed image) may be perceived by the user, and in this case, visibility may be reduced.

To prevent this phenomenon, the display device 100, according to an embodiment, may control the luminance (and refresh rate) of the displayed image when the refresh rate is switched and displayed.

In an embodiment, when a difference or ratio between the first refresh rate RR1 and the second refresh rate RR2 is outside a reference range, the image controller 125 may increase or decrease the luminance of the first frame (or at least one frame including the first frame) of the second period P2. When the difference or ratio between the first refresh rate RR1 and the second refresh rate RR2 is within the reference range, the image controller 125 may not additionally adjust the luminance of the second period P2.

In an embodiment, the image controller 125 may detect light characteristic information of an image to be displayed on the display panel 110 (or light emitted by the display panel 110) from the input image data IDATA (or image data DATA). Here, the light characteristic information may include a value of flashing luminance (or the peak luminance Lpk shown in FIG. 3B) in terms of the perceived luminance perceived by the user described with reference to FIGS. 3A and 3B.

For example, in an embodiment, the image controller 125 may detect the light characteristic information by predicting the value of flashing luminance that may occur when the refresh rate is switched.

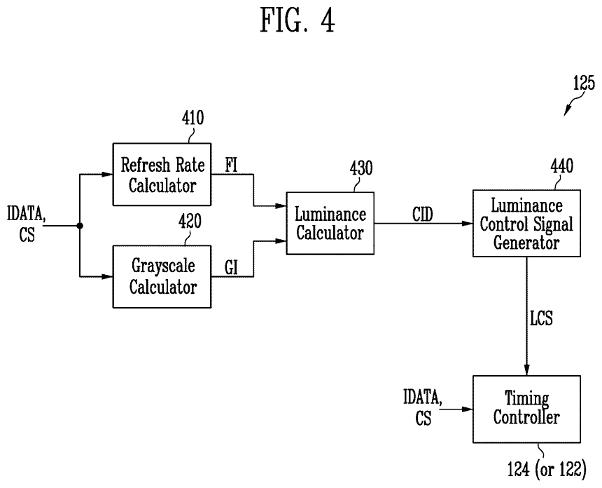

In an embodiment, the image controller 125 may compare the value of flashing luminance predicted when the refresh rate is switched according to the light characteristic information and the threshold value TV. The threshold value TV may be generated based on the input image data IDATA and the control signal CS, which will be described in detail with reference to FIG. 4.

In an embodiment, the image controller 125 may generate a luminance control signal LCS to control the luminance of the displayed image in response to the comparison result between the light characteristic information (for example, the value of flashing luminance) and the threshold value TV.

For example, in an embodiment, when the value of flashing luminance is greater than or equal to the threshold value TV, the image controller 125 may generate the luminance control signal LCS to gradually change the luminance.

In an embodiment and referring to FIG. 3A, when the display device 100 changes the refresh rate from the first refresh rate RR1 to the second refresh rate RR2 to display an image with the first luminance (or first average luminance Lav_A), the image controller 125 may generate the luminance control signal LCS to adjust the luminance of the image to a second luminance different from the first luminance in the first frame (at least one frame including the first frame) of the second period P2 driven at the second refresh rate RR2. When the second refresh rate RR2 is smaller than the first refresh rate RR1, the second luminance may be lower than the first luminance. The maximum luminance according to the second luminance may be between the first maximum luminance L_Amax1 of the first period P1 and the second maximum luminance L_Amax2 of the second period P2 (that is, the remaining period of the second period P2 excluding the at least one frame).

As another example, in an embodiment, in a third period (or third section) between the first period P1 and the second period P2, the image controller 125 may generate the luminance control signal LCS to adjust the luminance of the image to the second luminance, and to display the image at a third refresh rate in the third period. Here, the third refresh rate may have a value between the first refresh rate and the second refresh rate.

In an embodiment, when the value of flashing luminance is less than the threshold value TV, since the transient flashing phenomenon is not perceived by the user even if the refresh rate of the display device 100 is switched, the image controller 125 may generate the luminance control signal LCS so that the refresh rate of the display device 100 is immediately switched from the first refresh rate RR1 to the second refresh rate RR2. As an example, the display device 100 may be driven at the first refresh rate RR1 in the first period P1 and then switched to the second refresh rate RR2 in the second period P2 immediately after the first period P1. However, the invention is not limited thereto, and when the value of flashing luminance is greater than or equal to the threshold value, the image controller 125 may not generate a separate control signal (for example, the luminance control signal LCS).

In an embodiment, the image controller 125 may provide the luminance control signal LCS to the timing controller 124.

In an embodiment, the timing controller 124 may control the luminance of the displayed image based on the luminance control signal LCS. For example, the timing controller 124 may convert the input image data DATA1 into the image data based on the refresh rate and may adjust data of the first frame of the second period P2 (or data of the third period) by applying a weight according to the luminance control signal LCS. For example, the timing controller 124 may generate image data with a maximum data value or maximum grayscale value of A (or X/120) based on a refresh rate of about 120 Hz in the first period P1, generate image data with a maximum data value of B (or X/80) based on a refresh rate of about 80 Hz in the second period P2, and generate image data with a maximum data value of C (or X/100) between A and B in the first frame of the second period P2 or the third period.

In addition, based on the luminance control signal LCS, the timing controller 124 may control an output frequency of the data driver 122, an output frequency of the scan driver 121, and/or an output frequency of the emission driver 123 for one horizontal line (or pixel row). As an example, the timing controller 124 may control the output frequency of the scan driver 121 using the first control signal SCS (or scan drive control signal) and/or may control the output frequency of the data driver 122 using the second control signal DCS (or data drive control signal).

In another embodiment, in the first frame of the second period P2 or the third period, the timing controller 124 may control the data driver 122 to adjust the data signal instead of adjusting the image data DATA. For example, the data driver 122 may generate gamma voltages, select one of the gamma voltages based on the data value or grayscale value of the image data DATA to output the data signal, and adjust the gamma voltages based on the luminance control signal LCS. The luminance control signal LCS may be included in the second control signal DCS and provided from the timing controller 124 to the data driver 122, but the invention is not limited thereto. For example, the luminance control signal LCS may be provided from the image controller 125 to the data driver 122. For example, the data driver 122 may generate gamma voltages (or data signals) with a maximum gamma voltage of D (or Y/120) based on a refresh rate of about 120 Hz in the first period P1, generate gamma voltages with a maximum gamma voltage of E (or Y/80) based on a refresh rate of about 80 Hz in the second period P2, and generates gamma voltages with a maximum gamma voltage of F (or Y/100) between D and E in the first frame of the second period P2 or the third period.

As described above, the display device 100 (or the image controller 125), according to an embodiment, may control the luminance (and refresh rate) of the image based on the value of flashing luminance according to the light characteristic information of the image to be displayed on the display panel 110. Accordingly, even if the refresh rate of the display device 100 (or the displayed image) is switched, the transient flashing phenomenon perceived by the user can be prevented (for example, eliminated) and visibility can be improved.

In an embodiment, the image controller 125 may be composed of a separate integrated circuit chip (IC) from the timing control 124. However, the invention is not limited thereto. For example, all or part of the image controller 125 may be composed of an IC integrated with the timing controller 124. As another embodiment, all or part of the image controller 125 may be implemented in software in the timing controller 124.

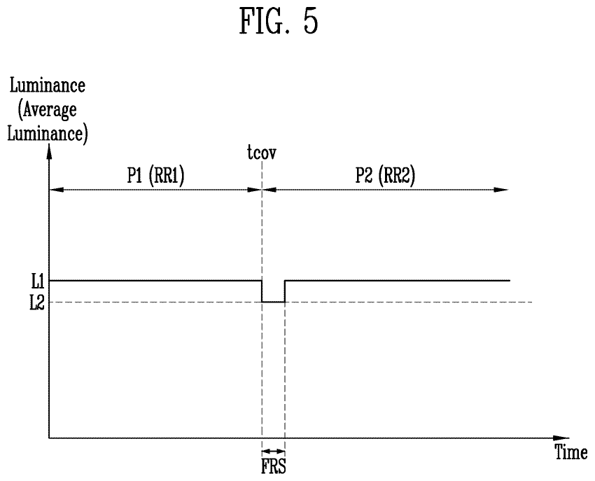

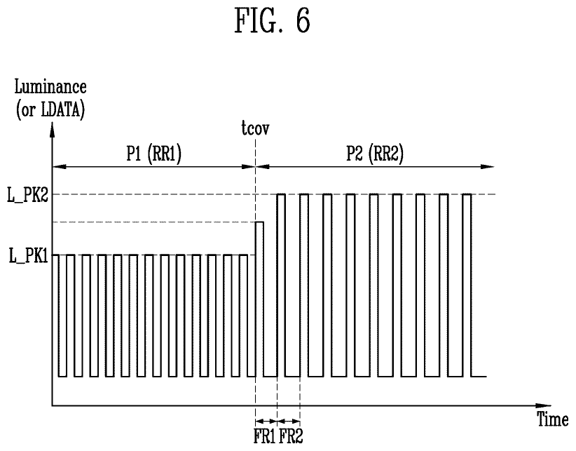

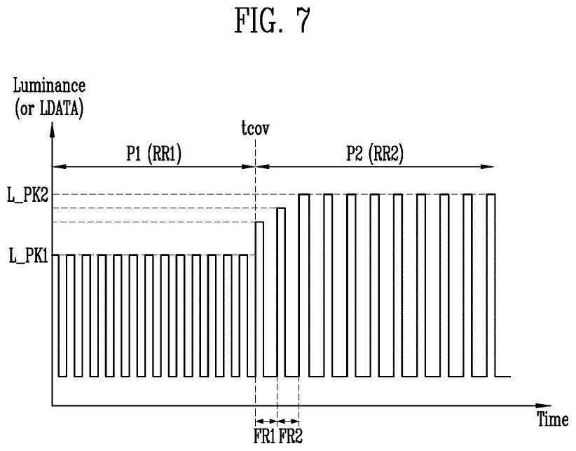

FIG. 4 is a block diagram illustrating an image controller included in the display device of FIG. 1, according to an embodiment. For convenience of description, the timing controller 124 is further shown in FIG. 4. FIGS. 5, 6, and 7 are diagrams illustrating changes in luminance according to changes in image refresh rate, according to an embodiment. FIG. 5 shows the average luminance for each frame, and FIGS. 6 and 7 show the actual luminance (or luminance data LDATA corresponding to the actual luminance).

In an embodiment and referring to FIGS. 1 and 4, the image controller 125 may include a refresh rate calculator 410, a grayscale calculator 420, a luminance calculator 430, and a luminance control signal generator 440.

The refresh rate calculator 410 may generate (or detect) refresh rate information FI corresponding to the refresh rate based on the control signal CS (and input image data IDATA). For example, the refresh rate calculator 410 may generate the refresh rate information FI based on a clock signal included in the control signal CS. However, this is merely an example, and the invention is not limited thereto. The refresh rate calculator 410 may generate the refresh rate information FI in various ways.

According to an embodiment, when an external device (for example, a processor) provides the refresh rate information FI or the refresh rate information FI is included in the control signal CS, the refresh rate calculator 410 may be omitted.

The grayscale calculator 420 may generate (or detect) grayscale information GI for a target image based on the input image data IDATA. For example, the grayscale calculator 420 may generate the grayscale information GI (or average grayscale value) by extracting grayscale values of the input image data IDATA or averaging the grayscale values. However, this is merely an example, and the invention is not limited thereto. The grayscale calculator 420 may generate the grayscale information GI in various ways.

The luminance calculator 430 may detect the light characteristic information of the image based on the refresh rate information FI and the grayscale information GI.

For example, in an embodiment, the luminance calculator 430 may detect a signal waveform of the image displayed by the display panel 110 based on the refresh rate information FI and the grayscale information GI. Here, the signal waveform may be the same or similar to the graph showing the actual luminance in FIG. 3A. For example, the luminance calculator 430 may calculate the peak luminance and/or average luminance of the image displayed by the display panel 110 based on the refresh rate information FI and the grayscale information GI or based on the signal waveform.

The luminance calculator 430 may determine the threshold value TV (see FIG. 3B) (or a first threshold value) based on the refresh rate information FI and the grayscale information GI.

In an embodiment, the luminance calculator 430 may determine the threshold value at which the transient flashing phenomenon is perceived by the user (for example, a flicker is perceived by the user) when the refresh rate is switched and an image is displayed.

For example, in an embodiment, based on the light characteristic information (for example, the signal waveform, the peak luminance, or the average luminance) of the image currently displayed by the display device 100 (or display panel 110), the luminance calculator 430 may determine the threshold value at which the transient flashing phenomenon is perceived by the user (for example, a flicker is perceived by the user) at the time point when the refresh rate is switched based on the refresh rate information FI and the grayscale information GI for the image to be displayed with the refresh rate switched.

In an embodiment, the luminance calculator 430 may determine the threshold value using a pre-stored look-up table LUT. The look-up table may include threshold values according to the light characteristic information (for example, the signal waveform, the peak luminance, or the average luminance), the refresh rate information FI, and the grayscale information GI of the image. The threshold values included in the look-up table may be experimentally determined based on the light characteristic information, the refresh rate, and the grayscale value of the image, but this is merely an example and the invention is not limited thereto.

In an embodiment, the luminance calculator 430 may calculate a value of predicted flashing luminance based on the refresh rate information FI and the grayscale information GI, or based on the light characteristic information of the image. For example, the luminance calculator 430 may calculate the value of flashing luminance using an activation function (or algorithm) that outputs the value of predicted flashing luminance for the refresh rate information FI and the grayscale information GI, but the invention is not limited thereto.

The luminance calculator 430 may compare the value of flashing luminance and the threshold value and generate target luminance data CID based on the comparison result. Here, the target luminance data CID may represent the luminance or a luminance adjustment ratio adjusted so that the flashing phenomenon is not perceived.

In an embodiment, when a maximum value of flashing luminance of the target image is greater than or equal to the threshold value, the luminance calculator 430 may generate the target luminance data CID to temporarily reduce the luminance of the display device 100.

For example, with reference to FIG. 5, when the display device 100 changes the refresh rate from the first refresh rate RR1 to the second refresh rate RR2 to display an image with a first luminance L1, the luminance calculator 430 may generate the target luminance data CID for adjusting the luminance of the image to a second luminance L2 that is different from the first luminance L1 in the first frame (or at least one frame FRS including the first frame) of the second period P2 driven at the second refresh rate RR2. Here, when the second refresh rate RR2 is smaller than the first refresh rate RR1, the second luminance L2 may be lower than the first luminance L1. Hereinafter, the first refresh rate RR1 may be about 120 Hz and the second refresh rate RR2 may be about 80 Hz. For example, the target luminance data CID may have a ratio of the second luminance L2 to the first luminance L1, a luminance adjustment ratio, or a value corresponding thereto.

For example, in an embodiment and with reference to FIG. 6, the luminance calculator 430 may calculate a first peak luminance L_PK1 (or the first maximum luminance) in the first period P1 based on the first refresh rate RR1 and the average grayscale value (for example, a grayscale value corresponding to the first luminance L1 in FIG. 5). The first peak luminance L PK1 may be a peak value according to the time of the image. In addition, the luminance calculator 430 may calculate a second peak luminance L PK2 (or the second maximum luminance) in the second period P2 based on the second refresh rate RR2 and the average grayscale value.

In an embodiment, in the process of switching from the first refresh rate RR1 to the second refresh rate RR2, when the value of flashing luminance is determined or predicted to be greater than or equal to the threshold value, the luminance calculator 430 may adjust the peak luminance of the first frame FR1 of the second period P2 to be between the first peak luminance L_PK1 according to the first refresh rate RR1 of the first period P1 and the second peak luminance L_PK2 according to the second refresh rate RR2 of the second period P2.

For example, the peak luminance of the first frame FR1 of the second period P2 may be within a range of about 85% to about 97% of the second peak luminance L_PK2. As a difference between the first refresh rate RR1 and the second refresh rate RR2 increases, or as a difference between the first peak luminance L_PK1 and the second peak luminance L_PK2 increases, the peak luminance of the first frame FR1 of the second period P2 may decrease. As an example, the luminance calculator 430 may determine a value of peak luminance of the first frame FR1 of the second period P2 by applying a weight function to the difference. When the peak luminance of the first frame FR1 of the second period P2 is less than about 85% of the second peak luminance L_PK2, a decrease in luminance may occur or be perceived in the second period P2.

For example, the peak luminance of the first frame FR1 of the second period P2 may be equal to an average of the first peak luminance L_PK1 and the second peak luminance L_PK2, or may be within a range of about ±10% of the average. For example, as the difference between the first refresh rate RR1 and the second refresh rate RR2 increases, or as the difference between the first peak luminance L_PK1 and the second peak luminance L_PK2 increases, the peak luminance of the first frame FR1 of the second period P2 may be smaller than an average of the first peak luminance L_PK1 and the second peak luminance L_PK2. When the peak luminance of the first frame FR1 of the second period P2 is lower than about −10% of the average, a decrease in luminance may occur or be perceived in the second period P2.

In an embodiment, the luminance control signal generator 440 may generate the luminance control signal LCS based on the target luminance data CID.

For example, in an embodiment, the luminance control signal generator 440 may determine a compensation value or compensation ratio of the input image data IDATA (or image data DATA) or a grayscale value included therein based on the target luminance data CID. The compensation value or compensation ratio may be included in the luminance control signal LCS. In this case, the timing controller 124 may convert the input image data IDATA into the image data DATA by reflecting the compensation value or compensation ratio. That is, compensated image data may be generated based on the compensation value or compensation ratio.

As another example, the luminance control signal generator 440 may determine a compensation value or compensation ratio of the gamma voltages based on the target luminance data CID. In this case, the data driver 122 may generate the gamma voltages by reflecting the compensation value or compensation ratio and generate the data signal corresponding to the image data DATA using the gamma voltages.

In an embodiment, when the maximum value of flashing luminance of the target image is less than the threshold value, the luminance calculator 430 may not generate the target luminance data CID. In this case, the luminance control signal generator 440 may not generate a separate control signal (for example, the luminance control signal LCS). However, the invention is not limited thereto. For example, in another embodiment, when the maximum value of flashing luminance of the target image is less than the threshold value, the luminance calculator 430 may generates the target luminance data CID corresponding to the original luminance (for example, the first luminance L1), and the luminance control signal generator 440 may generate the luminance control signal LCS to maintain the original luminance.

After the luminance adjustment is performed on the first frame FR1 of the second period P2, the luminance calculator 430 may detect the light characteristic information of the image of a second frame FR2 of the second period P2, determine the threshold value, and calculate the value of flashing luminance.

For example, when the maximum value of flashing luminance of the target image of the second frame FR2 of the second period P2 is less than the threshold value, the luminance calculator 430 may not generate the target luminance data CID, and the luminance control signal generator 440 may not generate the luminance control signal LCS. In this embodiment, in frames (for example, the second frame FR2) after the first frame of the second period P2, an image having the first luminance L1 or the second peak luminance L_PK2 according to the second refresh rate RR2 of the second period P2 may be displayed.

As another example, when the maximum value of flashing luminance of the target image of the second frame FR2 of the second period P2 is greater than or equal to the threshold value, as the same manner as the process of adjusting the luminance of the first frame FR1 of the second period P2, the luminance calculator 430 may generate the target luminance data CID for adjusting the luminance of the second frame FR2.

In an embodiment, the luminance control signal generator 440 may adjust the luminance of the second frame FR2 of the second period P2 to be between the luminance of the first frame FR1 of the second period P2 and the luminance (that is, the first luminance L1) of the second period P2. For example, the luminance control signal generator 440 may adjust the peak luminance of the second frame FR2 of the second period P2 to be between the peak luminance of the first frame FR1 of the second period P2 and the second peak luminance L_PK2 according to the second refresh rate RR2 of the second period P2. For example, the peak luminance of the second frame FR2 of the second period P2 may be about 85% to about 97% of the second peak luminance L PK2. For example, the peak luminance of the second frame FR2 of the second period P2 may be equal to an average of the peak luminance of the first frame FR1 and the second peak luminance L_PK2, or may be within about ±10% of the average. The peak luminance of the second frame FR2 may be greater than or equal to the first peak luminance. Through the above-described process, if necessary, the luminance of frames (for example, a third frame or the like) after the second frame FR2 of the second period P2 may also be adjusted.

As described above, the image controller 125 may detect the light characteristic information of the image based on the input image data IDATA and the control signal CS, compare the value of flashing luminance predicted according to the light characteristic information with the threshold value TV, and adjust the luminance of the first frame FR1 (and the second frame FR2) of the second period P2 displayed with the refresh rate switched. Accordingly, even if the refresh rate is switched, the transient flashing phenomenon perceived by the user can be prevented (for example, eliminated) and visibility can be improved.

In an embodiment and referring to FIG. 4, it has been explained that the light characteristic information, the threshold value, the value of flashing luminance, and the target luminance data CID of the image are sequentially calculated based on the refresh rate information FI and the grayscale information GI, but the present invention is not limited thereto. For example, a luminance adjustment ratio for each frame as the refresh rate changes from the first refresh rate RR1 to the second refresh rate RR2 may be stored as a look-up table. In this case, the image controller 125 may determine the luminance adjustment ratio (or target luminance data CID) for each frame based on the refresh rate information FI and the look-up table. For example, a first luminance adjustment ratio for the first frame FR1 may be stored in the look-up table, and the image controller 125 may adjust the luminance of the first frame based on the first luminance adjustment ratio. For example, when the difference or ratio between the first and second refresh rates is greater than a reference value, the first luminance adjustment ratio for the first frame as well as the second luminance adjustment ratio for the second frame may be stored in the look-up table, and the image controller 125 may adjust the luminance of the second frame based on the second luminance adjustment ratio.

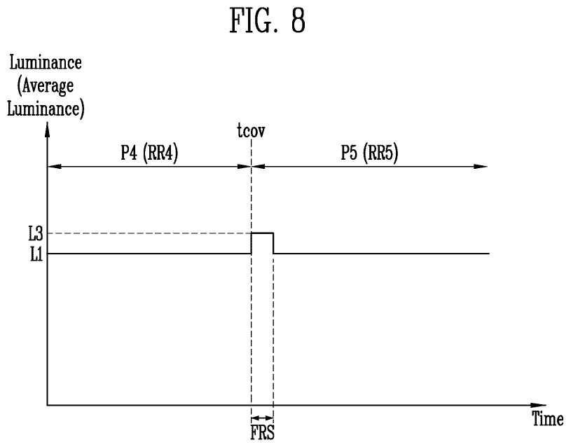

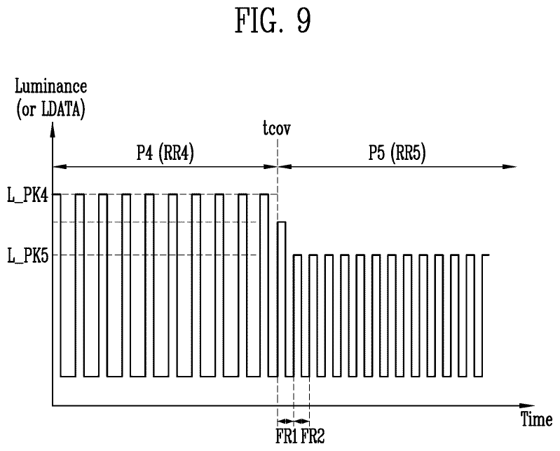

FIGS. 8 and 9 are diagrams illustrating changes in luminance according to changes in image refresh rate, according to an embodiment. FIG. 8 shows the average luminance for each frame, and FIG. 9 shows the actual luminance (or luminance data LDATA corresponding to the actual luminance). A fifth refresh rate RR5 may be greater than a fourth refresh rate RR4, and a third luminance L3 may be greater than the first luminance L1. Hereinafter, the fourth refresh rate RR4 may be 120 Hz, and the fifth refresh rate RR5 may be 80 Hz.

In an embodiment and referring to FIGS. 4, 8, and 9, in response to the time point at which the refresh rate is switched from a fourth period P4 to a fifth period P5 (for example, immediately after the fourth period P4), the perceived luminance may be momentarily decrease. When the perceived luminance is less than or equal to a second threshold value, even if the average luminance of the displayed image is the same when the refresh rate is switched, flicker (a decrease in luminance) may be perceived by the user the moment the refresh rate is switched. Here, the second threshold value may mean a reference value of luminance at which the user may perceive flicker (a decrease in luminance) when the refresh rate is switched.

In an embodiment, the luminance calculator 430 may determine the second threshold value based on the refresh rate information FI and the grayscale information GI.

In an embodiment, when the maximum value of flashing luminance of the target image is less than the second threshold value, the luminance calculator 430 may generate the target luminance data CID to temporarily increase the luminance of the display device 100.

For example, in an embodiment and with reference to FIG. 9, when the display device 100 changes the refresh rate from the fourth refresh rate RR4 to the fifth refresh rate RR5 to display an image with the first luminance L1, the luminance calculator 430 may generate the target luminance data CID for adjusting the luminance of the image to the third luminance L3 higher than the first luminance L1 in the first frame (or at least one frame FRS including the first frame) of the fifth period P5 driven at the fifth refresh rate RR5.

In an embodiment, in the process of switching from the fourth refresh rate RR4 to the fifth refresh rate RR5, when the value of flashing luminance is determined or predicted to be less than the second threshold value, the luminance calculator 430 may adjust the peak luminance of the first frame FR1 of the fifth period P5 to be between a fourth peak luminance L_PK4 according to the fourth refresh rate RR4 of the fourth period P4 and a fifth peak luminance L_PK5 according to the fifth refresh rate RR5 of the fifth period P5.

For example, the peak luminance of the first frame FR1 of the fifth period P5 may be about 103% to about 117% of the fifth peak luminance L_PK5. For example, as a difference between the fourth refresh rate RR4 and the fifth refresh rate RR5 increases, or as a difference between the fourth peak luminance L_PK4 and the fifth peak luminance L_PK5 increases, the peak luminance of the first frame FR1 of the fifth period P5 may increase. As an example, the luminance calculator 430 may determine a value of peak luminance of the first frame FR1 of the fifth period P5 by applying a weight function to the difference.

For another example, the peak luminance of the first frame FR1 of the fifth period P5 may be equal to an average of the fourth peak luminance L_PK4 and the fifth peak luminance L_PK5, or may be within about ±10% of the average. For example, as the difference between the fourth refresh rate RR4 and the fifth refresh rate RR5 increases, or as the difference between the fourth peak luminance L_PK4 and the fifth peak luminance L_PK5 increases, the peak luminance of the first frame FR1 of the period P5 may be greater than the average of the fourth peak luminance L_PK4 and the fifth peak luminance L_PK5.

In an embodiment, when the maximum value of flashing luminance of the target image is greater than or equal to the second threshold value, the luminance calculator 430 may not generate the target luminance data CID. In this case, the luminance control signal generator 440 may not generate a separate control signal (for example, the luminance control signal LCS). However, the invention is not limited thereto. For example, in another embodiment, when the maximum value of flashing luminance of the target image is greater than or equal to the second threshold value, the luminance calculator 430 may generate the target luminance data CID corresponding to the original luminance (for example, the first luminance L1), and the luminance control signal generator 440 may generate the luminance control signal LCS to maintain the original luminance.

Similar to adjusting the luminance of the second frame FR2 in FIG. 7, the luminance of the second frame FR2 of the fifth period P5 may also be adjusted.

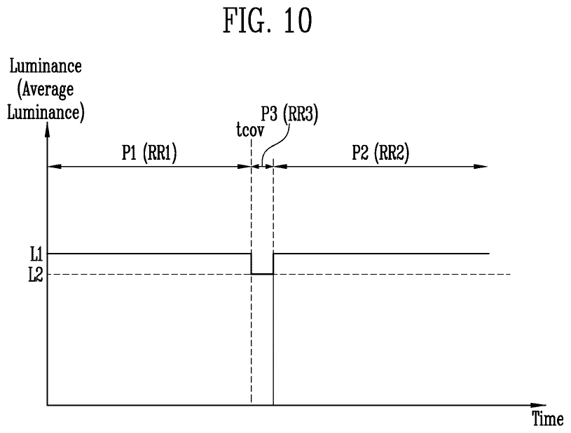

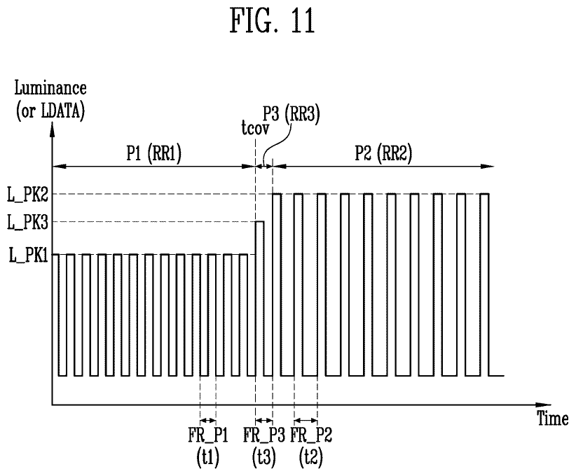

FIGS. 10 and 11 are diagrams illustrating changes in luminance according to changes in image refresh rate, according to an embodiment. FIG. 10 shows the average luminance for each frame, and FIG. 11 shows the actual luminance (or luminance data LDATA corresponding to the actual luminance).

In an embodiment and referring to FIGS. 4, 10, and 11, the image controller 125 may generate the luminance control signal LCS to control the luminance and refresh rate of the image. Embodiments of FIGS. 10 and 11 may differ from the embodiments of FIGS. 5 and 6 in that the refresh rate is additionally controlled. Except that the refresh rate is controlled, the embodiments of FIGS. 10 and 11 may be substantially the same or similar to the embodiments of FIGS. 5 and 6. Therefore, overlapping descriptions will not be repeated.

In an embodiment, when the difference or ratio between the first refresh rate RR1 and the second refresh rate RR2 is greater than the reference value, the image controller 125 may additionally adjust the refresh rate in addition to the luminance in a third period P3 between the first period P1 and the second period P2.

In an embodiment, when the maximum value of flashing luminance of the target image is greater than or equal to the threshold value, the luminance calculator 430 may generate the target luminance data CID to temporarily reduce the luminance of the display device 100.

For example, with reference to FIG. 10, when the display device 100 changes the refresh rate from the first refresh rate RR1 to the second refresh rate RR2 to display an image with the first luminance L1, the luminance calculator 430 may generate the target luminance data CID so that an image of the second luminance L2 is displayed at a third refresh rate RR3 in the third period P3 (or a bridge period) between the period P1 and the second period P2. Here, the third refresh rate RR3 may have a value between the first refresh rate RR1 and the second refresh rate RR2. For example, the first refresh rate RR1 may be about 120 Hz, the second refresh rate RR2 may be 80 Hz, and the third refresh rate RR3 may be a value greater than about 80 Hz and less than about 120 Hz, for example, 100 Hz.

According to an embodiment, the luminance calculator 430 may control a value of the third refresh rate RR3 based on a difference between the threshold value TV and the maximum value of flashing luminance. For example, as the difference between the threshold value TV and the maximum value of flashing luminance increases, the luminance calculator 430 may control the third refresh rate RR3 to have a larger value.

In an embodiment and referring to FIG. 11, since the third refresh rate RR3 is greater than the second refresh rate RR2 and less than the first refresh rate RR1, the length (shown as ‘t3’) of each frame FR P3 in the third period P3 may be longer than the length (shown as ‘t2’) of each frame FR P2 in the second period P2 and may be shorter than the length (shown as ‘t1’) of each frame FR P1 in the first period P1.

In an embodiment, the luminance calculator 430 may adjust the peak luminance in the third period P3, that is, the third peak luminance L_PK3, to be between the first peak luminance L PK1 according to the first refresh rate RR1 of the first period P1 and the second peak luminance L_PK2 according to the second refresh rate RR2 of the second period P2. The third peak luminance L_PK3 may be determined in the same manner as the method of determining the peak luminance of the first frame FR1 of the second period P2 described with reference to FIG. 6.

In an embodiment, the third period P3 may include a plurality of frames. For example, the third period P3 may include two or less frames. Peak luminances in the plurality of frames of the third period P3 may be the same, but the invention is not limited thereto. For example, in another embodiment, similar to the peak luminance of the first frame FR1 and the peak luminance of the second frame FR2 of the second period P2 described with reference to FIG. 7, the peak luminances in the frames of the third period P3 may be increased step by step.

As described above, when changing the refresh rate from the first refresh rate RR1 to the second refresh rate RR2 to display an image, the image controller 125 may adjust the refresh rate as well as the luminance in the third period P3 between the first period P1 driven at the first refresh rate RR1 and the second period P2 driven at the second refresh rate RR2/

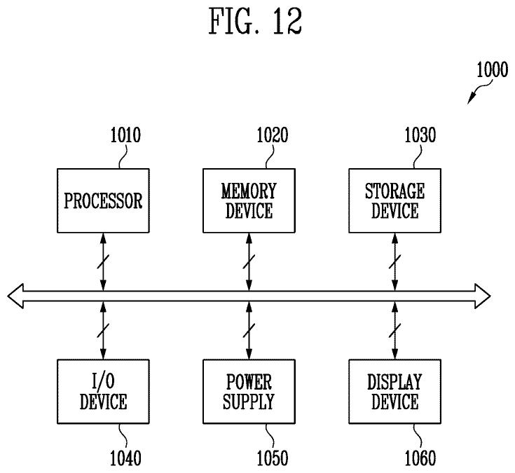

FIG. 12 is a block diagram illustrating an electronic device, according to an embodiment.

In an embodiment and referring to FIG. 12, an electronic device 1000 may include a processor 1010, a memory device 1020, a storage device 1030 an input/output device 1040, a power supply 1050, and a display device 1060. In this case, the display device 1060 may be the display device 100 of FIG. 1. In addition, the electronic device 1000 may further include several ports that can communicate with a video card, a sound card, a memory card, a universal serial bus (USB) device, and the like, or with other systems. In an embodiment, the electronic device 1000 may be implemented as television, a tablet PC, a navigation device, a smartphone, a mobile phone, a video phone, an e-book reader, a desktop PC, a laptop PC, a netbook computer, a work station, a server, a PDA, a portable multimedia player (PMP), an MP3 player, a medical device, a camera, a wearable device, or the like.

The processor 1010 may perform specific calculations or tasks. According to one embodiment, the processor 1010 may be a microprocessor, a central processing unit, an application processor, or the like. The processor 1010 may be connected to other components through an address bus, a control bus, a data bus, and the like. According to an embodiment, the processor 1010 may also be connected to an expansion bus, such as a peripheral component interconnect (PCI) bus.

According to an embodiment, the processor 1010 may change the image refresh rate.

The memory device 1020 may store data necessary for the operation of the electronic device 1000. For example, the memory device 1020 may include a non-volatile memory device such as an EPROM (erasable programmable read-only memory) device, an EEPROM (electrically erasable programmable read-only memory) device, a flash memory device, a PRAM (phase change random access memory) device, a RRAM (resistance random access memory) device, a NFGM (nano floating gate memory) device, a PoRAM (polymer random access memory) device, a MRAM (magnetic random access memory) device, or a FRAM (ferroelectric random access memory) device, and/or a volatile memory device such as a DRAM (dynamic random access memory) device, a SRAM (static random access memory) device, or a mobile DRAM device.

The storage device 1030 may include a solid state drive (SSD), a hard disk drive (HDD), a compact disc read only memory (CD-ROM), or the like.

The input/output device 1040 may include an input means such as a keyboard, a keypad, a touchpad, a touch screen, and a mouse, and an output means such as a speaker and a printer. According to an embodiment, the display device 1060 may be included in the input/output device 1040.

The power supply 1050 (or power supply device) may supply the power required to operate the electronic device 1000. For example, the power supply 1050 may be a power management integrated circuit (PMIC).

In an embodiment, the display device 1060 may display an image corresponding to visual information of the electronic device 1000. In this case, the display device 1060 may be an organic light emitting display device or a quantum dot light emitting display device, but the invention is not limited thereto. In another embodiment, he display device 1060 may be connected to other components through the buses or other communication links.

The display device and the electronic device according to an embodiment may control the luminance of an image by comparing the flashing luminance of an image calculated based on input image data with a threshold value. Accordingly, even if an image refresh rate of the display device is switched, the phenomenon of transient flashing (or flicker) perceived by a user can be prevented or eliminated. Accordingly, visibility can be improved.

Example embodiments have been disclosed herein, and although specific terms are employed, they are used and are to be interpreted in a generic and descriptive sense only and not for purpose of limitation. In some instances, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the invention. Thus, while various embodiments have been described above, those skilled in the art will appreciate that various modifications, additions and substitutions are possible, without departing from the scope and spirit of the invention.

What is claimed is:

1. A display device comprising:
a display panel including a pixel and displaying an image; and
a driver converting input image data into image data, generating a data signal based on the image data, and providing the data signal to the pixel according to a refresh rate,
wherein when changing the refresh rate from a first refresh rate to a second refresh rate to display an image with a first luminance, the driver adjusts a luminance of a first frame in which the image is displayed at the second refresh rate to a second luminance which is different from the first luminance.

2. The display device of claim 1, wherein when the second refresh rate is smaller than the first refresh rate, the driver reduces the second luminance to be lower than the first luminance.

3. The display device of claim 2, wherein in response to a change in the refresh rate, the driver changes an on-duty, which represents a ratio of time the pixel emits light during one frame, and a peak luminance according to the time of the image.

4. The display device of claim 2, wherein the driver adjusts the peak luminance according to the time of the image in the first frame to be between a first peak luminance according to the first refresh rate and a second peak luminance according to the second refresh rate.

5. The display device of claim 4, wherein the peak luminance of the first frame is within a range of about 85% to about 97% of the second peak luminance.

6. The display device of claim 4, wherein the peak luminance of the first frame is within a range of about ±10% of an average of the first peak luminance and the second peak luminance.

7. The display device of claim 4, wherein the driver selects one of gamma voltages based on a grayscale value of the image data for the pixel and outputs the selected one of gamma voltages as the data signal, and sets gamma voltages in the first frame to be different from gamma voltages for the second peak luminance.

8. The display device of claim 4, wherein the driver converts the input image data into the image data based on the refresh rate, and applies a weight to generate the image data of the first frame.

9. The display device of claim 2, wherein the driver drives the display panel to display the image having the first luminance in a second frame after the first frame.

10. The display device of claim 2, wherein when a difference between the first refresh rate and the second refresh rate is greater than a reference value, the driver adjusts the luminance of a second frame after the first frame to be between the first luminance and the second luminance.

11. The display device of claim 1, wherein when the second refresh rate is smaller than the first refresh rate, the driver increases the second luminance to be higher than the first luminance.

12. The display device of claim 1, wherein when a difference or ratio between the first refresh rate and the second refresh rate is outside of a reference range, the driver adjusts the luminance of the first frame to the second luminance, and
wherein when the difference or ratio is within the reference range, the driver maintains the luminance of the first frame at the first luminance.

13. An electronic device comprising:
a processor providing input image data; and
a display device displaying an image having a first luminance corresponding to the input image data,
wherein when the processor changes a refresh rate of the image from a first refresh rate to a second refresh rate, the display device displays the image at a second luminance which is different from the first luminance for at least one frame, and displays the image at the first luminance after the at least one frame.

14. The electronic device of claim 13, wherein when the second refresh rate is smaller than the first refresh rate, the display device reduces the second luminance to be lower than the first luminance.

15. The electronic device of claim 14, wherein the display device changes a peak luminance according to a time of the image according to the refresh rate, and adjusts the peak luminance in the at least one frame to be between a first peak luminance according to the first refresh rate and a second peak luminance according to the second refresh rate.

16. A display device comprising:
a display panel including a pixel and displaying an image; and
a driver converting input image data into image data, generating a data signal based on the image data, and providing the data signal to the pixel according to a refresh rate,
wherein when changing the refresh rate from a first refresh rate to a second refresh rate to display an image with a first luminance, in a third section between a first section displaying the image at the first refresh rate and a second section displaying the image at the second refresh rate, the driver adjusts a luminance of the image to a second luminance which is different from the first luminance.

17. The display device of claim 16, wherein the driver adjusts the refresh rate of the image to a third refresh rate which is different from the first refresh rate and the second refresh rate in the third section.

18. The display device of claim 17, wherein the third refresh rate is a value between the first refresh rate and the second refresh rate.

19. The display device of claim 16, wherein the driver changes a peak luminance according to a time of the image according to the refresh rate, and adjusts the peak luminance in the third section to be between a first peak luminance according to the first refresh rate and a second peak luminance according to the second refresh rate.

20. The display device of claim 16, wherein the third section includes two or less frames.
